(19) United States
(12) Patent Application Publication
(10) Pub. No.: US 2023/0034293 A1
(43) Pub. Date: Feb. 2, 2023

(54) WATERPROOF AND SHATTERPROOF LIGHT STRING CAPABLE OF BEING QUICKLY PLUGGED IN

(71) Applicant: DONGGUAN GUANYI LIGHT-DECORATION CO., LTD., Dongguan (CN)

(72) Inventor: SHIFANG WANG, Dongguan (CN)

(21) Appl. No.: 17/404,982

(22) Filed: Aug. 17, 2021

(30) Foreign Application Priority Data
Jul. 27, 2021 (CN) 202121721380.X

(51) Int. Cl. F21S 4/10; F21V 23/00; F21V 23/06; F21V 31/00

(52) U.S. Cl. CPC F21S 4/10; F21V 23/001; F21V 23/06; F21V 31/005

(57) ABSTRACT

The present disclosure relates to the technical field of lighting lamps, and provides a waterproof and shatterproof light string capable of being quickly plugged in. A first wire is included, one end of the first wire is provided with a female socket, and the other end of the first wire is provided with a male plug; and the wire is connected with a plurality of lamp holder devices in parallel, one end of a second wire is connected with the first wire in a sealed mode, the other end of the second wire is connected with a lamp holder shell in a sealed mode, the lamp holder shell is installed with a bulb and a lamp housing of the bulb is sealed with an opening of the lamp holder shell.

### TECHNICAL FIELD

The present disclosure herein relates to the technical field of lighting lamps, in particular to a waterproof and shatterproof light string capable of being quickly plugged in.

### BACKGROUND

The lighting technology in the today's society is mature, and the application range of lamps is very broad. The lamps are connected in series or parallel for combination to form light strings, and then fixed to artificial trees, walls, fences, ceilings and other places. Existing light strings in operation are affected by environmental factors such as wind, which can easily cause damage to the lamps and even bulb fractures. The lighting light string on the market has a poor waterproof effect and cannot operate for a long time in wind and rain. At the same time, existing plugs are usually convenient for people to use, and in use, whether they are plugged in the forward direction or in the reverse direction, this will not affect the use. However, when many light string circuits need to be connected in series, existing sockets cannot meet their needs, because serial connection of light strings needs to strictly distinguish positive and negative poles. Therefore, most of the existing light strings are usually electrically connected manually, in this way, low connection efficiency is caused and potential safety hazards exist. For this purpose, the inventor provides a waterproof and shatterproof light string capable of being quickly plugged in.

### SUMMARY

The present disclosure aims to provide a waterproof and shatterproof light string capable of being quickly plugged in aiming at defects in the prior art, which has advantages of being quickly plugged in, waterproof and shatterproof.

In order to achieve the above purpose, the waterproof and shatterproof light string capable of being quickly plugged in of the present disclosure comprises a first wire, one end of the first wire is provided with a female socket, and the other end of the first wire is provided with a male plug; and the wire is connected with a plurality of lamp holder devices in parallel, the lamp holder device includes a second wire and a lamp holder shell, one end of the second wire is connected with the first wire in a sealed mode, the other end of the second wire is connected with the lamp holder shell in a sealed mode, the lamp holder shell is installed with a bulb and a lamp housing of the bulb is sealed with an opening of the lamp holder shell.

Further, a security bin is arranged in the male plug, and one side of the male plug is provided with a movable valve for closing the security bin.

Preferably, the male plug is provided with a first sealing cover for sealing the security bin.

Further, a front end of the male plug is provided with a first male tab and a second male tab, and the first male tab is greater than the second male tab.

Preferably, the female socket is provided with a first jack matched with the first male tab and a second jack matched with the second male tab.

Further, a front end of the female socket is provided with an accommodating position, the accommodating position can accommodate the front end of the male plug and sealed connection is formed.

Preferably, the female socket is further provided with a second sealing cover for sealing the accommodating position.

Further, the lamp holder shell is integrally molded.

Further, the lamp housing of the bulb is made of a shatterproof transparent plastic material.

Further, the first wire is connected with the male plug, the female socket and the lamp holder device in a sealed mode.

Beneficial effects: compared with the prior art, the waterproof and shatterproof light string capable of being quickly plugged of the present disclosure includes the first wire, one end of the first wire is provided with the female socket, and the other end of the first wire is provided with the male plug; and the wire is connected with the plurality of lamp holder devices in parallel, one end of the second wire is connected with the first wire in the sealed mode, the other end of the second wire is connected with the lamp holder shell in the sealed mode, the lamp holder shell is installed with the bulb and the lamp housing of the bulb is sealed with the opening of the lamp holder shell. The present disclosure has the following advantages that 1. the male plug and the female socket are provided with the male tabs of different sizes of the positive and negative poles and the corresponding jacks, can be quickly plugged and electrically conductive, and are convenient and safe in use; 2. the first wire is connected with the male plug, the female socket, and the lamp holder devices in the sealed mode, and the plug, the socket and lamp holders all have a waterproof structure and are good in waterproof effect; and 3. the lamp housing of the bulb is made of the transparent plastic material, is not prone to produce cracks when it is collided by an external force, and has high shatterproof performance.

### BRIEF DESCRIPTION OF FIGURES

FIG. 1 is a schematic structural diagram of a light string of the present disclosure;

FIG. 2 is a schematic structural diagram of a lamp holder device of the present disclosure;

FIG. 3 is a schematic stereoscopic diagram of a lamp holder shell of the present disclosure;

FIG. 4 is a schematic stereoscopic structural diagram of a female socket of the present disclosure; and

FIG. 5 is a schematic stereoscopic structural diagram of a male plug of the present disclosure; and

FIG. 6 is a schematic front-side structural diagram of the male plug of the present disclosure.

### REFERENCE NUMERALS INCLUDE

First wire—1, female socket—2, first jack—21, second jack—22, accommodating position—23, second sealing cover—24, male plug—3, security bin—31, movable valve—32, fuse—33, first sealing cover—34, first male tab—35, second male tab—36, lamp holder device—4, second wire—41, lamp holder shell—42, bulb—43.

### DETAILED DESCRIPTION

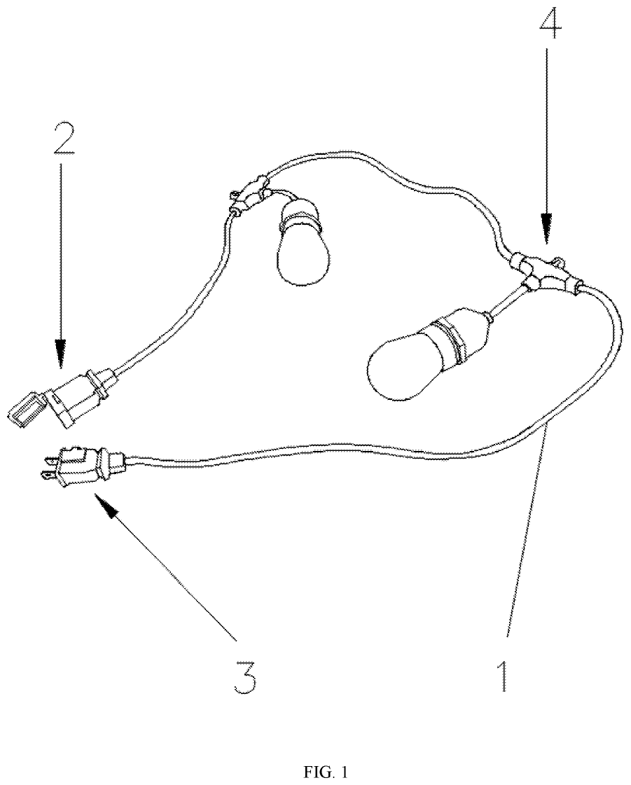

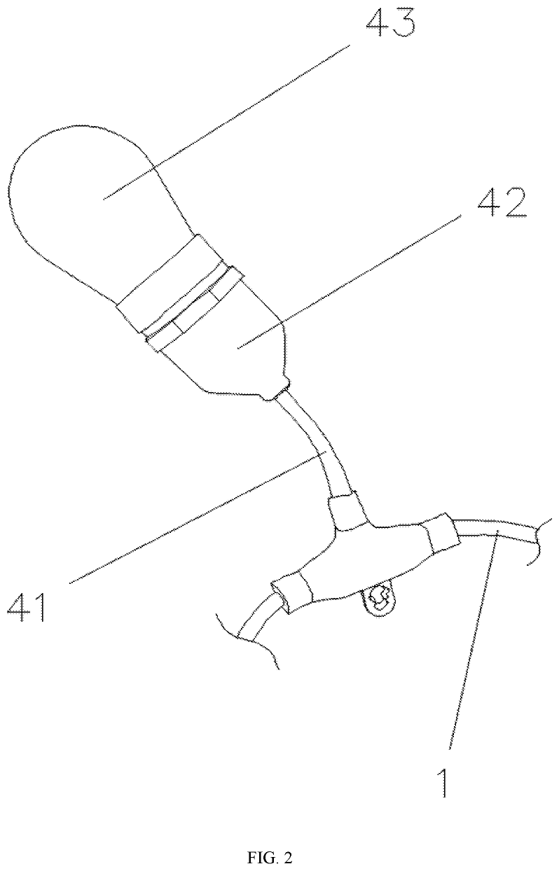

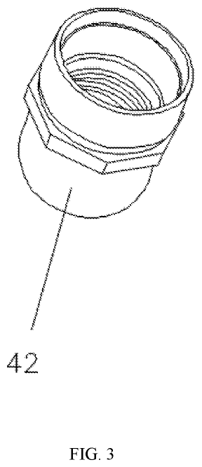

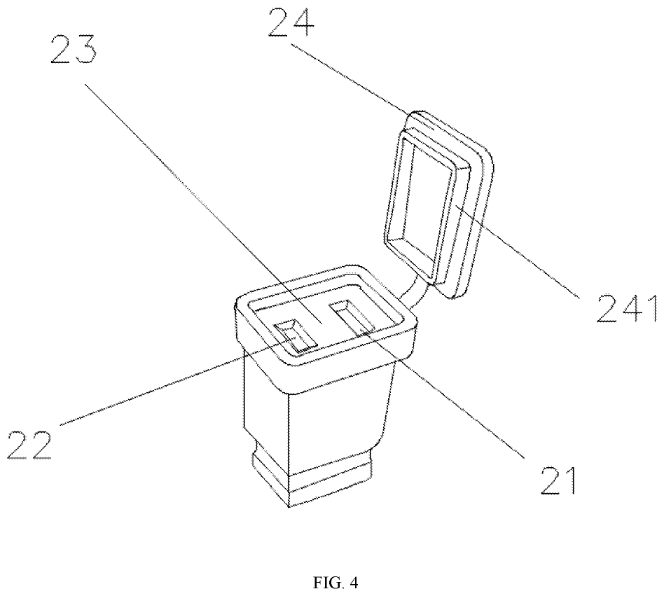

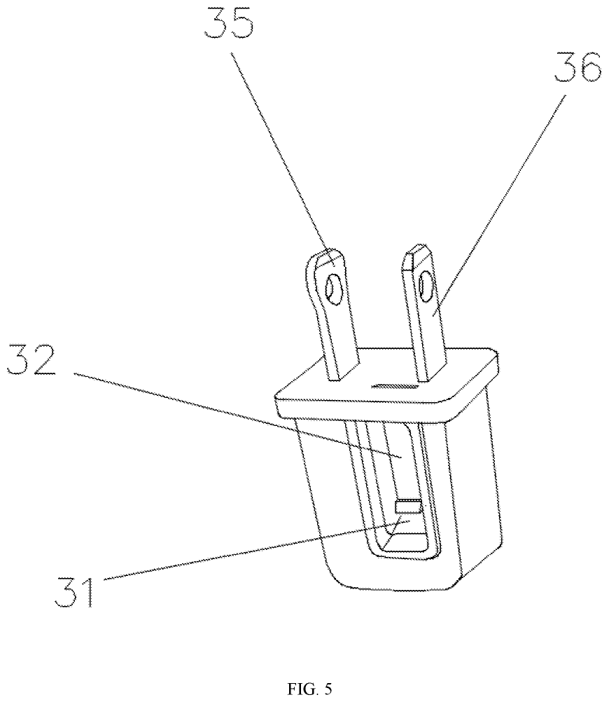

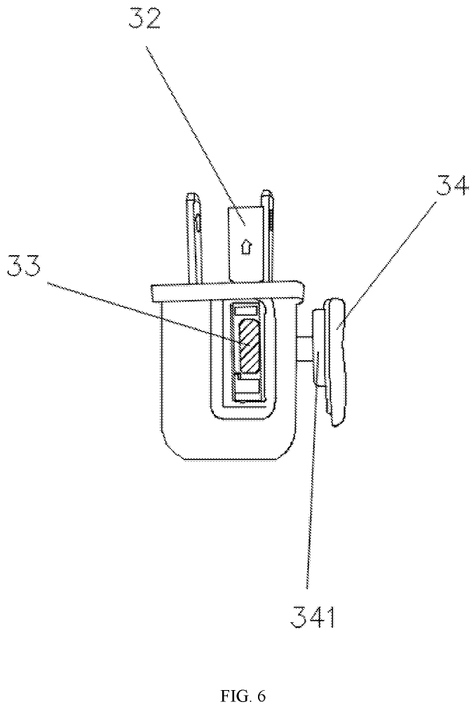

The present disclosure is explained below in detail in conjunction with FIGS. 1-6.

A waterproof and shatterproof light string capable of being quickly plugged in of the present disclosure includes a first wire 1, one end of the first wire 1 is provided with a female socket 2, and the other end of the first wire 1 is provided with a male plug 3; and the wire is connected with a plurality of lamp holder devices 4 in parallel, the lamp holder device 4 includes a second wire 41 and a lamp holder shell 42, one end of the second wire 41 is connected with the first wire 1 in a sealed mode, the other end of the second wire 41 is connected with the lamp holder shell 42 in a sealed mode, the lamp holder shell 42 is installed with a bulb 43 and a lamp housing of the bulb 43 is sealed with an opening of the lamp holder shell 42. The light string of the present disclosure is light strings connected in parallel, the light string is plugged in a power supply through the male plug 3 for power-on lighting. When a plurality of light strings need to be connected in series, the male plug 3 of the light string added later can be plugged to the female socket 2 of the previous light string for parallel connection conduction. A plug plugging mode is adopted, and plugging is convenient and fast; and in an open-air scene, the light string needs to be hung on a hard wall for lighting, the lamp holder shell 42 is made of a plastic material, there is certain elasticity, damage caused by the collision caused by external forces such as wind can be substantially reduced, and the service life of the light string is prolonged. The opening of the lamp holder shell 42 is in a shape of a flat circle and an opening end is slightly closed to the middle, and thin plastic is adopted so that it has the characteristic of being soft. After the bulb 43 is installed on a lamp holder, the lamp housing and the opening of the lamp holder shell 42 can be sealed, rainwater and other liquids are prevented from permeating into the lamp holder to cause a leakage and a short circuit, and safety performance is high.

Shells of the male plug 3 and the female socket 2 of the present disclosure are both made of a plastic material and have slight elasticity. The male plug 3 is internally provided with a security bin 31, and one side of the male plug 3 is provided with a movable valve 32 for closing the security bin 31. In this technical solution, a fuse 33 for electrically conducting positive and negative poles is arranged in the security bin 31. When a circuit is abnormal, the fuse 33 is fused, relevant staff can open the movable valve 32 to replace the fuse 33, and operation is easy, convenient and fast.

In terms of a waterproof structure, the male plug 3 is provided with a first sealing cover 34 for sealing the security bin 31. By pressing a cap of the first sealing cover 34 with fingers, a protruding block 341 in the middle of the first sealing cover 34 is squeezed into an opening of the security bin 31 to form sealing, thereby preventing liquid from entering the security bin 31 through the movable valve 32.

A front end of the male plug 3 is provided with a first male tab 35 and a second male tab 36, and the first male tab 35 is greater than the second male tab 36; the female socket 2 is provided with a first jack 21 matched with the first male tab 35 and a second jack 22 matched with the second male tab 36. The positive and negative poles are distinguished by the size of the male tab and the plug. When a direct current is connected, the corresponding electrode can be quickly identified and connected. When the positive and negative poles of the male plug 3 and the female socket 2 are plugged oppositely, the first male tab 35 does not match the second jack 22 and cannot be inserted, which reduces the occurrence of electricity accidents.

A front end of the female socket 2 is provided with an accommodating position 23, the accommodating position 23 can accommodate the front end of the male plug 3, and sealed connection is formed. The female socket 2 and the male plug 3 are in a sealed state when connected, which can prevent water mist from penetrating, and connection between the female socket 2 and the male plug 3 can be more stable in the sealed state.

The female socket 2 is also provided with a second sealing cover 24 for sealing the accommodating position 23. A cap of the second sealing cover 24 is wider than the accommodating position. A plug block 241 matched and sealed with the accommodating position 23 is arranged at one end of the second sealing cover 24. When a next light string is not connected in series, the female socket 2 is generally in an idle state. After the second sealing cover 24 covers the accommodating position 23, it can prevent excessive dust and moisture from entering the jack of the female socket 2, which further prolongs the service life of the light string.

In terms of a further waterproof structure, the lamp holder shell 42 is integrally molded. After the bulb 43 is installed on the lamp holder, the lamp housing and the opening of the lamp holder shell 42 are sealed to prevent rainwater and other liquids from penetrating into the lamp holder to cause a leakage and a short circuit; and safety performance is high.

The lamp housing of the bulb 43 is made of a shatterproof transparent plastic material. When the light string is collided by an external force, the lamp housing made of the transparent plastic material is not prone to produce cracks due to collision, and shatterproof performance is high.

The first wire 1 is connected with the male plug 3, the female socket 2, and the lamp holder device 4 in a sealed mode. According to the above description, the second wire 41 and the lamp holder shell 42 connected with the lamp holder device 4 are in sealed connection. The lamp holder shell 42 is integrally molded. After the bulb 43 is installed on the lamp holder, the lamp housing and the opening of the lamp holder shell 42 are sealed. The bulb 43 which has already been installed on the lamp holder can also be safely powered on for lighting even when immersed in water. The light string of the present disclosure has excellent waterproof performance.

The above content is only the preferred examples of the present disclosure. For those of ordinary skill in the art, according to the ideas of the present disclosure, there will be changes in the specific implementation and the scope of application, and the content of the present description should not be understood as limitations to the present disclosure.

1. A waterproof and shatterproof light string capable of being quickly plugged in, comprising a first wire, wherein, one end of the first wire is provided with a female socket, and the other end of the first wire is provided with a male plug;
the wire is connected with a plurality of lamp holder devices in parallel, the lamp holder device comprises a second wire and a lamp holder shell, one end of the second wire is connected with the first wire in a sealed mode, the other end of the second wire is connected with the lamp holder shell in a sealed mode, the lamp holder shell is installed with a bulb and a bulb housing of the bulb is sealed with an opening of the lamp holder shell;
wherein the lamp holder shell is an integral one piece that is integrally molded.

2. The waterproof and shatterproof light string capable of being quickly plugged in according to claim 1, wherein, a security bin is arranged in the male plug, and one side of the male plug is provided with a movable valve for closing the security bin.

3. The waterproof and shatterproof light string capable of being quickly plugged in according to claim 2, wherein, the male plug is provided with a first sealing cover for sealing the security bin, wherein the first sealing cover comprises cap and a protruding block connected to the cap, wherein the cap is operative to be pushed to drive the protruding block to be squeezed into an opening of the security bin to achieve sealing.

4. The waterproof and shatterproof light string capable of being quickly plugged in according to claim 1, wherein a front end of the male plug is provided with only two male tabs including a first male tab and a second male tab, and wherein the first male tab is greater than the second male tab.

5. The waterproof and shatterproof light string capable of being quickly plugged in according to claim 4, wherein, the female socket is provided with a first jack matched with the first male tab and a second jack matched with the second male tab.

6. The waterproof and shatterproof light string capable of being quickly plugged in according to claim 1, wherein, a front end of the female socket is provided with an accommodating position, the accommodating position can accommodate a front end of the male plug and sealed connection is formed.

7. The waterproof and shatterproof light string capable of being quickly plugged in according to claim 6, wherein, the female socket is further provided with a second sealing cover for sealing the accommodating position.

8. The waterproof and shatterproof light string capable of being quickly plugged in according to claim 1, wherein, the lamp holder shell is integrally molded.

9. The waterproof and shatterproof light string capable of being quickly plugged in according to claim 1, wherein, the bulb housing of the bulb is made of a shatterproof transparent plastic material.

10. The waterproof and shatterproof light string capable of being quickly plugged in according to claim 1, wherein, the first wire is connected with the male plug, the female socket and the lamp holder device in a sealed mode.
